(19) United States
(12) Patent Application Publication
(10) Pub. No.: US 2009/0040107 A1
(43) Pub. Date: Feb. 12, 2009

(54) SMART ANTENNA SUBSYSTEM

(75) Inventors: Louis Yun, Los Altos, CA (US); Ali M. Niknejad, Berkeley, CA (US)

Correspondence Address: WILSON SONSINI GOODRICH & ROSATI, 650 PAGE MILL ROAD, PALO ALTO, CA, 94304-1050, US

(73) Assignee: HMicro, Inc., Los Altos, CA (US)

(21) Appl. No.: 12/138,398

(22) Filed: Jun. 12, 2008

Related U.S. Application Data
(60) Provisional application No. 60/943,538, filed on Jun. 12, 2007.

(51) Int. Cl. H01Q 3/22

(52) U.S. Cl. 342/375

(57) ABSTRACT

The present invention provides several smart antenna devices and methods. The devices and methods incorporate a programmable delay element into each RF pathway, which enables smart antennas to receive not only narrow band signals but also ultra-wide band signals at low cost and low power consumption, while in a highly reliable fashion. The devices and methods therefore enable a low complexity smart antenna receiver as part of a highly reliable, low cost and low power sensor network.

### CROSS-REFERENCE

This application claims the benefit of U.S. Provisional Application No. 60/943,538, filed Jun. 12, 2007, which application is incorporated herein by reference.

### BACKGROUND OF THE INVENTION

Wireless sensor networks have a wide variety of applications in monitoring, tracking and controlling, including health monitoring, traffic monitoring, object tracking, fire detection, and nuclear reactor control. The explosive growth in demand for wireless radio frequency communications necessitates increased efficiency in use of the radio frequency spectrum. In response to the problem extensive efforts have been applied to the development of antenna systems that use some form of scanning technique to improve network performance. Multiple techniques have been demonstrated such as space-diversity combining switched/multiple-beam arrays, RF scanning arrays, and digital beam forming. Each of the described techniques is based on the premise that a more directive beam scanned over a wide angle will result in reduced mutual interference thereby improving system performance for both coverage and capacity. These systems have been referred to as smart or adaptive antennas that change radiation pattern in response to a changing signal environment. As data rates go up, for example when communicating with ultra wideband (UWB) radio, the current smart antenna systems can become cumbersome and expensive. Thus, there is a need for smart antenna systems and methods that can operate at high data rates and for smart antenna systems that can be used with UWB radio signals.

### SUMMARY OF THE INVENTION

An aspect of the invention is a smart antenna receiver comprising multiple antennas which receive analog signals, wherein each antenna is connected to a RF combiner through (i) a variable gain amplifier, and (ii) a programmable RF delay element, wherein the RF combiner combines the analog signals into a combined analog signal, wherein the RF combiner is connected to an analog to digital converter (ADC) that converts the combined analog signal to a digital signal; wherein the ADC is connected to a microprocessor, wherein the microprocessor receives the digital signals from the ADC, wherein the microprocessor is connected to the programmable RF delay elements and the variable gain amplifiers for each of the m antennas such that the microprocessor can adjust the delay setting of the programmable RF delay elements and the gain setting on the variable gain amplifiers, and wherein the microprocessor evaluates the digital signals obtained at various gain and/or delay settings to select gain and delay settings that produce a high quality signal.

In some embodiments, the smart antenna receiver has 2-12 antennas.

In some embodiments, the smart antenna receiver has 2, 3, or 4 antennas.

In some embodiments, each antenna is connected to a RF combiner to an analog to digital converter (ADC) additionally through a RF filter.

In some embodiments, a down converter is included between each antenna and the analog to digital converter (ADC).

An aspect of the invention is a smart antenna receiver comprising multiple antennas which receive analog signals, each antenna connected to an microprocessor through (i) a variable gain amplifier, and (ii) a programmable RF delay element, and (iii) an analog to digital converter (ADC), such that the signals received at the microprocessor are delayed, amplified, and converted from analog to digital signals, wherein the microprocessor combines the digital signals from the m antennas, and wherein the microprocessor is connected to the programmable RF delay elements and the variable gain amplifiers for each of the m antennas such that the microprocessor can adjust the delay setting of the programmable RF delay elements and the gain setting on the variable gain amplifiers, and wherein the microprocessor evaluates the digital signals obtained at various gain and/or delay settings in order to select gain and delay settings that produce a high quality signal.

In some embodiments, the smart antenna receiver has 2-12 antennas.

In some embodiments, the smart antenna receiver has 2, 3, or 4 antennas.

In some embodiments, each antenna is connected to a RF combiner to an analog to digital converter (ADC) additionally through a RF filter.

In some embodiments, a down converter is included between each antenna and the analog to digital converter (ADC).

An aspect of the invention is a smart antenna receiver comprising m antennas which receive analog signals, each antenna is connected to a RF combiner through (i) a variable gain amplifier, and (ii) a programmable RF delay element, wherein the RF combiner combines the signals, wherein the RF combiner is connected to a sample and hold circuit that convert the combined analog signals to digital signals; wherein the sample and hold circuit is connected to a microprocessor, wherein the microprocessor receives the digital signal from the sample and hold circuit, wherein the microprocessor is connected to the programmable RF delay elements and the variable gain amplifiers for each of the m antennas such that the microprocessor can adjust the delay setting of the programmable RF delay elements and the gain setting on the programmable amplifiers, and wherein the microprocessor evaluates the digital signals obtained at various gain and/or delay settings in order to select gain and delay settings that produce a high quality signal.

In some embodiments, the smart antenna receiver has 2-12 antennas.

In some embodiments, the smart antenna receiver has 2, 3, or 4 antennas.

In some embodiments, each antenna is connected to a RF combiner to an analog to digital converter (ADC) additionally through a RF filter.

In some embodiments, a down converter is included between each antenna and the analog to digital converter (ADC).

An aspect of the invention is a smart antenna transmit device comprising a splitter that splits an analog baseband signal into multiple split signals, and comprising multiple transmit chains each comprising a programmable delay element, a variable gain amplifier, and an antenna, wherein each of the delay elements and amplifiers is connected to a microprocessor, wherein the microprocessor can adjust the gain of the amplifiers and the delay of the delay elements.

In some embodiments, the smart antenna further comprises an upconverter between the analog baseband signal and the splitter.

In some embodiments, the smart antenna further comprises an upconverters between the splitter and each antenna.

In some embodiments, the smart antenna further comprises a RF filter between the splitter and each antenna.

In some embodiments, the smart antenna has 2, 3, 4, 5, or 6 antennas.

An aspect of the invention is a method for processing and transferring a received radio signal comprising: (a) receiving m first analog signals at m antennas; (b) applying a first set of m gains and a first set of m delays to the m first analog signals; (c) combining the m first analog signals from the multiple antennas into a combined first analog signal; (d) converting the combined first analog signal into a first digital signal; (e) receiving the first digital signal at a microprocessor; (f) receiving m second analog signals at the m antennas; (g) applying a second set of m gains and a second set of m delays to the m second analog signals; (h) combining the m second analog signals from the multiple antennas into a combined second analog signal; (i) converting the combined second analog signal into a second digital signal; and (j) receiving the second digital signal at the microprocessor, wherein the microprocessor evaluates the quality of the first digital signal and the second digital signal; and select the gain and delay settings so as to transfer the digital signal with high quality.

In some embodiments, the multiple antennas comprise 2, 3, 4, 5, or 6 antennas.

In some embodiments, the method further comprising applying steps (f) through (j) to 1, 2, 3, 4, 5, or 6 additional signals and in step (j) further evaluating the quality of the additional signals.

In some embodiments, in step (j) the quality comprises BER, SNR, SIR, SINR, error vector measurement, background noise and/or interference power, or RSSI.

In some embodiments, converting the one analog signal a digital signal is performed by an ADC.

In some embodiments, converting the one analog signal a digital signal is performed by a sample and hold circuit.

In some embodiments, a set of stored weight vectors comprising a set of gain settings and delay settings is used by the microprocessor to set the gain and delay to the analog signals.

In some embodiments, the quality of a digital signal is used by the microprocessor to set a gain, delay or both to subsequent analog signals.

In some embodiments, the method is applied to a UWB signal.

In some embodiments, the method is applied to a narrowband signal.

An aspect of the invention is a method for processing and transferring a received radio signal comprising: (a) receiving m first analog signals at m antennas; (b) applying a first set of m gains and a first set of m delays to the m first analog signals; (c) converting the signals from step (b) into m first digital signals; (d) receiving the m first digital signals at a microprocessor; (e) receiving m second analog signals at the m antennas; (f) applying a second set of m gains and a second set of m delays to the m second analog signals; (g) converting signals from step (f) into m second digital signals; and (h) receiving the m second digital signals at the microprocessor; wherein the microprocessor combines the m first digital signals into a combined first digital signal, combines the m second digital signals into a combined second digital signal, evaluates the quality of the first combined digital signal and the second combined digital signal; and select the gain and delay settings so as to transfer the combined digital signal with high quality.

In some embodiments, the multiple antennas comprise 2, 3, 4, 5, or 6 antennas.

In some embodiments, the method further comprising applying steps (e) through (h) to 1, 2, 3, 4, 5, or 6 additional signals and in step (h) further evaluating the quality of the additional signals.

In some embodiments, in step (h) the quality comprises BER, SNR, SIR, SINR, error vector measurement, background noise and/or interference power, or RSSI.

In some embodiments, converting the one analog signal a digital signal is performed by an ADC.

In some embodiments, converting the one analog signal a digital signal is performed by a sample and hold circuit.

In some embodiments, a set of stored weight vectors comprising a set of gain settings and delay settings is used by the microprocessor to set the gain and delay to the analog signals.

In some embodiments, the quality of a digital signal is used by the microprocessor to set a gain, delay or both to subsequent analog signals.

In some embodiments, the method is applied to a UWB signal.

In some embodiments, the method is applied to a narrowband signal.

An aspect of the invention is a method of transmitting a signal from a smart antenna comprising: (a) sending an analog baseband signal to a splitter which splits the signal into m split signals: (b) applying a set of m gains and m delays to the m split signals; (c) transmitting the m split signals through m antennas (d) repeating steps (a) through (c) with another set of m gains and m delays.

In some embodiments, the analog baseband signal is upconverted before it reaches the splitter.

In some embodiments, each of the m split signals are upconverted before being transmitted by the m antennas.

In some embodiments, each of the m split signals are filtered before being transmitted by the m antennas.

In some embodiments, the multiple antennas comprise 2, 3, 4, 5, or 6 antennas.

In some embodiments, the repeating in step (d) is done 2, 3, 4, 5, 6, 7, or 8 times.

In some embodiments, a set of stored weight vectors comprising a set of gain settings and delay settings is used by the microprocessor to set the gain and delay to the analog signals.

In some embodiments, the quality of a digital signal is used by the microprocessor to set a gain, delay or both to subsequent analog signals.

In some embodiments, the method is applied to a UWB signal.

In some embodiments, the method is applied to a narrowband signal.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1a illustrates a smart antenna receiver structure according to one of the embodiments of the present invention where a RF combiner combines all the RF signals received by the antennas into one composite RF signal, which is then optionally downconverted to either a composite baseband signal or a composite IF signal, and then converted into a digital signal by an analog to digital converter before being processed by a microprocessor.

FIG. 1b illustrates a smart antenna receiver structure according to one of the embodiments of the present invention where the RF signals received by the antennas are downconverted to IF signals, and an IF combiner combines all the IF signals into one composite IF signal. The composite IF signal is then optionally further downconverted to a combined baseband signal. The combined IF signal or the combined baseband signal is then optionally converted into a digital signal by an analog to digital converter before being processed by a microprocessor.

FIG. 2a illustrates a smart antenna receiver structure according to one of the embodiments of the present invention where a RF combiner combines all the analog signals received by the antennas into one analog signal, which is optionally downconverted, then processed by a sample and hold circuit comprising a slicer before being processed by a microprocessor.

FIG. 2b illustrates a smart antenna receiver structure according to one of the embodiments of the present invention where the RF signals received by the antennas are optionally downconverted, then combined by an analog combiner into one analog signal, which is then processed by a sample and hold circuit comprising a slicer before being processed by a microprocessor.

FIG. 3 illustrates a smart antenna receiver structure according to one of the embodiments of the present invention where all the analog signals received by the antennas are converted into digital signals and are combined and processed by a microprocessor.

FIG. 4 illustrates a smart antenna transmitter structure according to one of the embodiments of the present invention where an analog baseband signal is optionally upconverted, applied to a splitter, and each individual split signal then optionally upconverted, amplified by a variable gain amplifier and delayed by a programmable delay element before being transmitted on the antenna. The splitter may be applied to the analog baseband signal, or alternatively to the upconverted IF signal, or to the upconverted RF signal.

### DETAILED DESCRIPTION OF THE INVENTION

A smart antenna used in this invention combines an antenna array with a digital signal-processing capability to transmit or receive signals in an adaptive spatially sensitive manner. Such a system can automatically change the directionality of its radiation patterns in response to its signal environment.

The current invention includes several smart antenna devices and methods that incorporate into each RF pathway a programmable delay element and a variable gain element that can compensate for the differences in delay and attenuation of the radio signal experienced by the different elements of an antenna array. These devices and methods make it possible to generate a low complexity smart antenna receiver or transmitter for wireless communication, and more specifically as part of a highly reliable, low cost and low power sensor network.

The smart antennas and methods of this invention can enable an effective sensor network. Such sensor network usually consists of sensor nodes which are low cost, have long battery life, and communicate with a central base station over secure and highly reliable links. The network can utilize asymmetric data rates, for example, with the transmission of data collected by the sensor nodes to a base station consuming much more bandwidth that the command and control data transmitted by the base station to the sensor nodes. The low cost, low power requirements of this network structure can utilize a highly integrated, low processing complexity sensor node. An ultra-wideband radio generally has very low probability of intercept for increased security, and with current advances in RF design, is capable of very low power operation, in some cases lower than narrowband radios for similar applications. For achieving maximum RF coexistence, the smart antennas of the present invention are a synergistic complement to an ultra-wideband radio; and the asymmetry of the data transmission and the complexity constraints on the sensor node suggest the need for high reliability may be met, for example, with simple, uni-antenna sensor nodes and smart antenna processing at the base station.

One aspect of the invention is a smart antenna system that is designed to be capable of transmitting or receiving ultra-wide band (UWB) signals. The Federal Communications Commission (FCC) defines UWB as fractional bandwidth measured at −10 DB points where (f_high−f_flow)/f_center >20% or total Bandwidth >500 MHz. UWB can be used at very low energy levels for short-range high-bandwidth communications by using a large portion of the radio spectrum. UWB communications transmit in a way that doesn't interfere largely with other more traditional ‘narrow band’ and continuous carrier wave uses in the same frequency band. FDA has stringent requirements on the use of RF technology in medical devices, especially the challenges of wireless co-existence and wireless quality of service. Unlike narrowband systems, in which uncoordinated spectrum usage by different users can lead to catastrophic outages, an ultra-wideband radio is inherently designed for RF coexistence: its very low power spectral density, regulated in the U.S. by FCC emission masks, makes it less intrusive to other users sharing the same spectrum. However, a conventional UWB radio is vulnerable to jamming and saturation of its receiver front end, especially by strong narrowband interferers. The addition of smart antenna processing provides the UWB system with interference mitigation capabilities, allowing it to coexist with other narrowband and wideband users sharing the same spectrum who act as potential interferers. In addition, smart antenna processing also provides processing gain over thermal noise, thereby increasing the overall signal-to-interference-and-noise-ratio. Reliability can be further enhanced by exploiting the very wide bandwidth of UWB to implement powerful, low-rate error correction codes.

An ultra wide band (UWB) channel is a function of space and time, and compensating for its dispersive nature purely through digital baseband processing can be computationally expensive. One aspect of the invention is introducing programmable delay taps directly into the RF paths, and driving the delays to compensate for the dispersion using a closed loop smart antenna algorithm. This approach is made possible with recent advances in RF phase shifters capable of generating picosecond resolution time delays from DC to 12 GHz and being digitally controlled. As used herein, the terms “RF phase shifter” and “RF delay element” are used interchangeably.

In other embodiments, the smart antenna system used in this invention can transmit or receive narrowband signals. Narrowband radio, as used herein, is any radio that is not ultra-wideband (UWB) radio. For example, the Federal Communications Commission (FCC) defines UWB as fractional bandwidth measured at −10 dB points where (f_high−f_low)/f_center >20% or total Bandwidth >500 MHz. Some examples of the narrowband radios suitable for the present invention are: Wi-Fi standard based radio, Bluetooth standard based radio, Zigbee standard based radio, MICS standard based radio, and WMTS standard based radio. Suitable wireless radio protocols include WLAN and WPAN systems.

One aspects of the invention is a smart antenna device. Such smart antenna device has multiple antennas which transmit or receive analog signals. In a smart antenna receiver device, each antenna is connected to a RF combiner through a variable gain amplifier, and a programmable RF delay element. The RF combiner combines the analog signals into a combined analog signal. Alternatively, the signals from the antenna may first undergo downconversion to either an intermediate frequency (IF) or to baseband prior to being combined by an analog combiner. The IF combined signal may optionally further undergo downconversion into a baseband combined signal. The combined signal (either IF or baseband) is then converted by an analog to digital converter (ADC) into a digital signal. The ADC is connected to a microprocessor, wherein the microprocessor receives the digital signals from the ADC. The microprocessor is connected to the programmable RF delay element and the variable gain amplifier for each of the antennas such that the microprocessor can adjust the delay setting of the programmable RF delay elements and the gain setting on the variable gain amplifiers. The microprocessor evaluates the digital signals obtained at various gain and/or delay settings to select gain and delay settings that produce a high quality signal.

The smart antenna device of the present invention has multiple antennas. In some cases, the smart antenna device has 2 to 20 antennas. In some cases, it has 2 to 12 antennas. In some cases, it has 2, 3, or 4 antennas.

In some embodiments, each antenna is connected to a RF combiner and further to an analog to digital converter (ADC) additionally through a RF filter. A RF filter used in this invention is an electrical circuit configuration (network) designed to have specific characteristics with respect to the transmission or attenuation of various frequencies that may be applied to it.

In some embodiments, each antenna connected to a RF combiner to an analog to digital converter (ADC) additionally through a down converter, which can bring the signal into the proper frequency band. A down converter may operate to convert a signal from RF to IF frequency, from RF to baseband, or from IF to baseband.

A variable gain amplifier used in this invention is an electronic amplifier that varies gain depending on a control voltage, which can be adjusted by the microprocessor. In some embodiments, the variable gain amplifier is applied to the RF signal from the antenna. In other embodiments, the variable gain amplifier is applied to the IF signal or the analog baseband signal.

The programmable RF phase shifter or RF delay element utilized in this invention produces a delay in the signal received by an antenna in the receiver. The phase shifter can be, for example, an analog phase shifter. In some cases, the receivers are used to receive signals at high data rates. The receivers can be used, for example for ultra wide band (UWB) receivers that operate at data rates of up to 500 MHz or higher. For receiving signals with high data rates, a phase shifter that can produce short duration delays is useful. For example, phase shifters capable of phase shifts of 1 ps to 1 ns, 10 ps to 100 ps, or 10 ps to 50 ps delays can be used in the present invention. A phase shifter capable of achieving 15 ps and 27 ps delay variation.

An analog to digital converter (ADC) used in this invention is an electronic integrated circuit, which converts continuous analog signal to discrete digital numbers. In some embodiments, an analog to digital converter (ADC) is replaced with a simpler sample and hold circuit to implement a very low cost receiver front end. A sample and hold circuit used in this invention can sample the analog signal and hold the analog value steady for a short time while the slicer can further make a decision on the held value into detected bits.

A RF combiner used in this invention is an electronic device that can combine multiple radio signals into one single RF signal. The RF combiner used herein is generally an analog RF combiner. In some embodiments, an analog IF combiner, which operates at intermediate frequencies, or an analog baseband combiner, which operates at baseband, may be used instead of the RF combiner.

A microprocessor can be a central processing unit (CPU) contained within a single chip. The microprocessor of the present invention is also referred to herein as a smart antenna processor. The microprocessor used in this invention can evaluate digital signals or detected bits to make a determination of signal quality. The microprocessor used in this invention is connected to the various gain amplifiers and programmable RF delay elements such that it can adjust the gain and delay settings of the signal it received based on its evaluation of the signal quality.

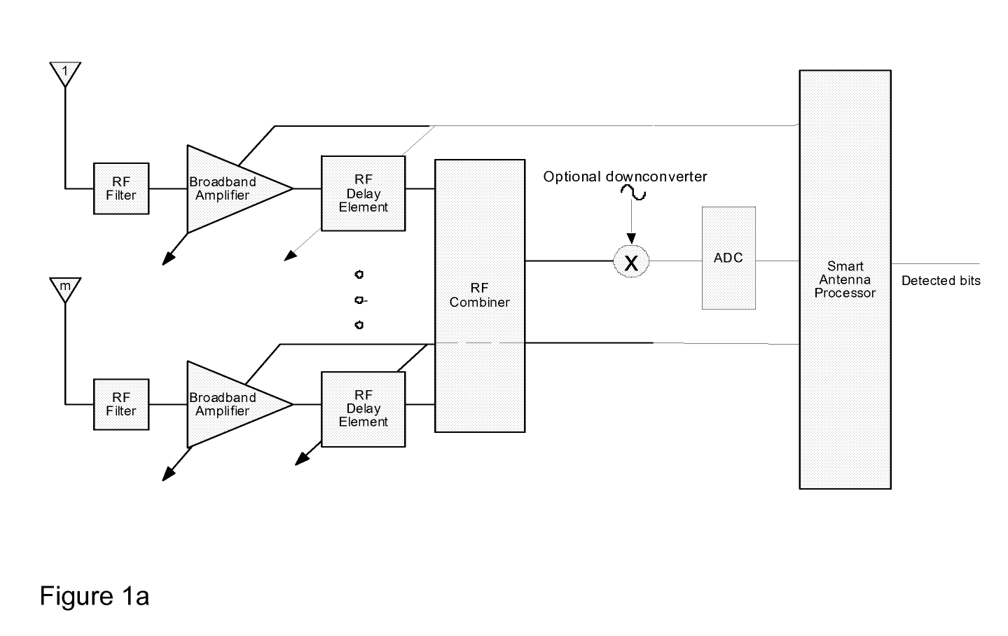

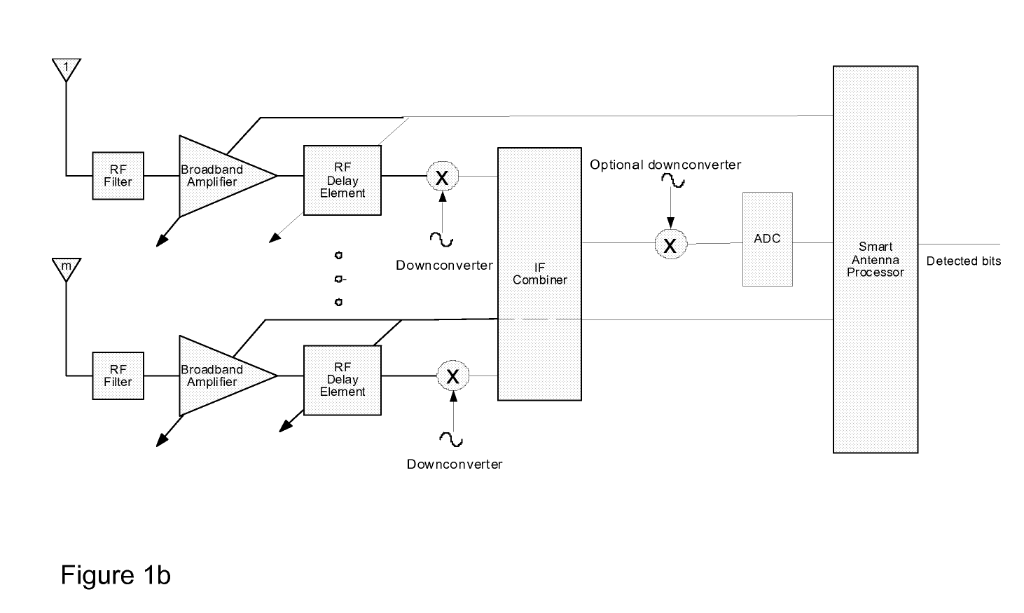

FIG. 1a shows an exemplary embodiment where each of m antennas is connected to a RF combiner through a RF filter, a broadband amplifier and RF delay element. The RF combiner is connected to an analog to digital converter (ADC) through a downconverter wherein the combined analog signal is converted into a digital signal which is then received by the smart antenna processor. The smart antenna processor is connected to the broadband amplifiers and RF delay elements such that it can adjust the gain and/or delay settings

FIG. 1b shows an exemplary embodiment where each of m antennas is connected to an IF combiner through a RF filter, a broadband amplifier, a RF delay element and a downconverter. The IF combiner combines all m IF signals into one composite IF signal. The composite IF signal is then optionally further downconverted to a combined baseband signal through an optional downconverter. The combined IF signal or the combined baseband signal is then converted into a digital signal by an analog to digital converter (ADC) before being processed by a microprocessor. The smart antenna processor is connected to the broadband amplifiers and RF delay elements such that it can adjust the gain and/or delay settings.

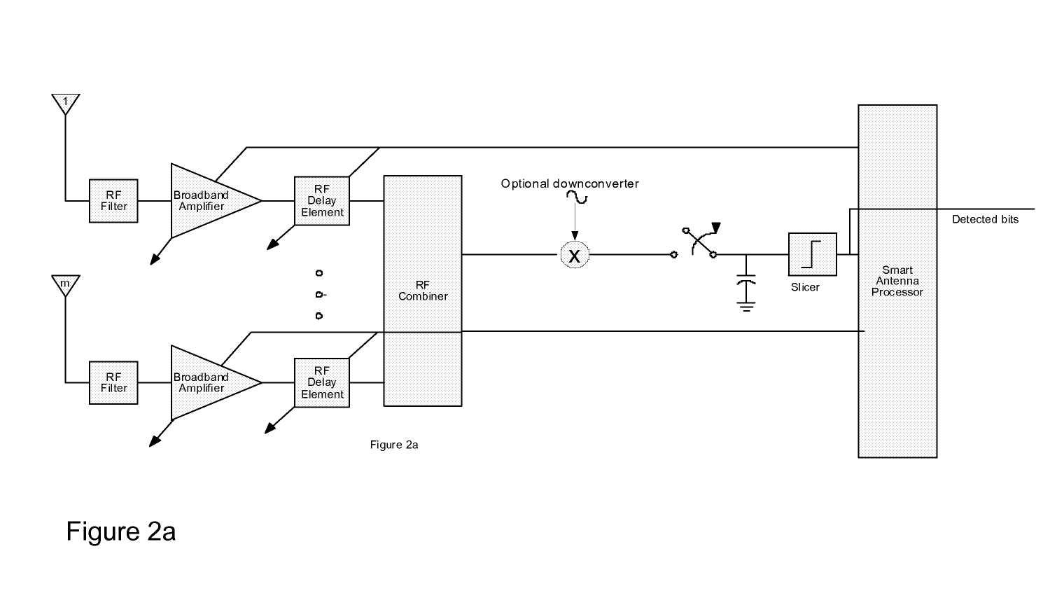

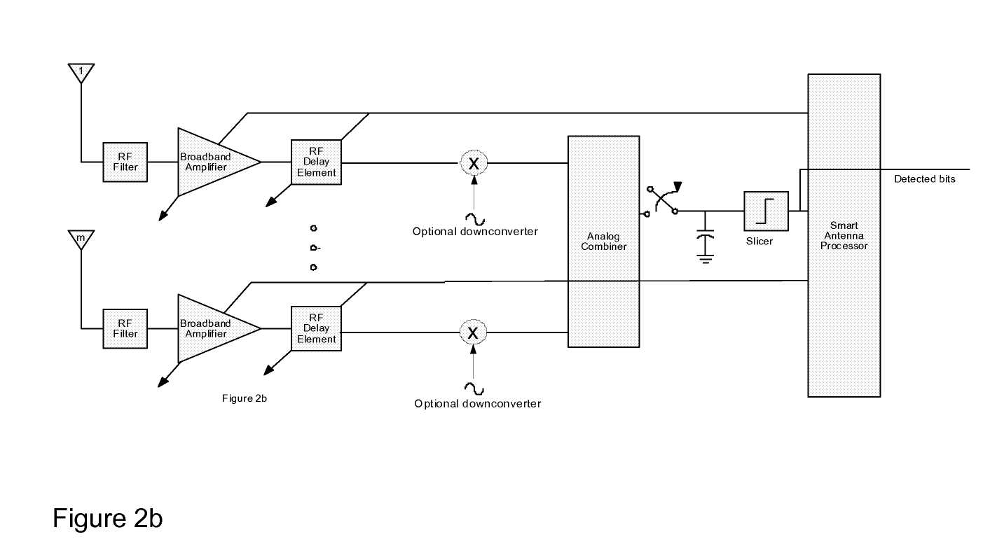

FIG. 2a shows an exemplary embodiment where each of m antennas is connected to a RF combiner through a RF filter, a broadband amplifier and RF delay element. The RF combiner is connected to a sample and hold circuit comprising a slicer through an optional down converter. The combined and downconverted signal is processed by the sample and hold circuit into detected bits which are then received by the smart antenna processor. The smart antenna processor is connected to the broadband amplifiers and RF delay elements such that it can adjust the gain and/or delay settings.

FIG. 2b shows an exemplary embodiment where each of m antennas is connected to an analog combiner through a RF filter, a broadband amplifier, a RF delay element and an optional downconverter. The analog combiner is connected to a sample and hold circuit comprising a slicer wherein the combined analog signal is processed into detected bits before being processed by a microprocessor. The smart antenna processor is connected to the broadband amplifiers and RF delay elements such that it can adjust the gain and/or delay settings.

One aspect of the invention is a smart antenna device. Such smart antenna has multiple antennas which transmit receive analog signals. In a smart antenna receiver device, each antenna is connected to a microprocessor through a variable gain amplifier and a programmable RF delay element, and an analog to digital converter (ADC) such that the signals received at the microprocessor are delayed, amplified, and converted from analog to digital signals. The microprocessor combines the digital signals from the multiple antennas. The microprocessor is connected to the programmable RF delay element and the variable gain amplifier for each of the antennas such that the microprocessor can adjust the delay setting of the programmable RF delay elements and the gain setting on the variable gain amplifiers. The microprocessor evaluates the digital signals obtained at various gain and/or delay settings in order to select gain and delay settings that produce a high quality signal.

The smart antenna device of the present invention has multiple antennas. In some cases, the smart antenna device has 2 to 20 antennas. In some cases, it has 2 to 12 antennas. In some cases, it has 2, 3, or 4 antennas.

In some embodiments, each antenna connected to an analog to digital converter (ADC) additionally through a RF filter. A RF filter used in this invention is an electrical circuit configuration (network) designed to have specific characteristics with respect to the transmission or attenuation of various frequencies that may be applied to it.

In some embodiments, an analog IF combiner, which operates at intermediate frequencies, or an analog baseband combiner, which operates at baseband, may be used instead of the RF combiner. In some embodiments, each antenna connected to an analog to digital converter (ADC) additionally through a down converter, which can bring the signal into the proper frequency band. A down converter may operate to convert a signal from RF to IF frequency, from RF to baseband, or from IF to baseband.

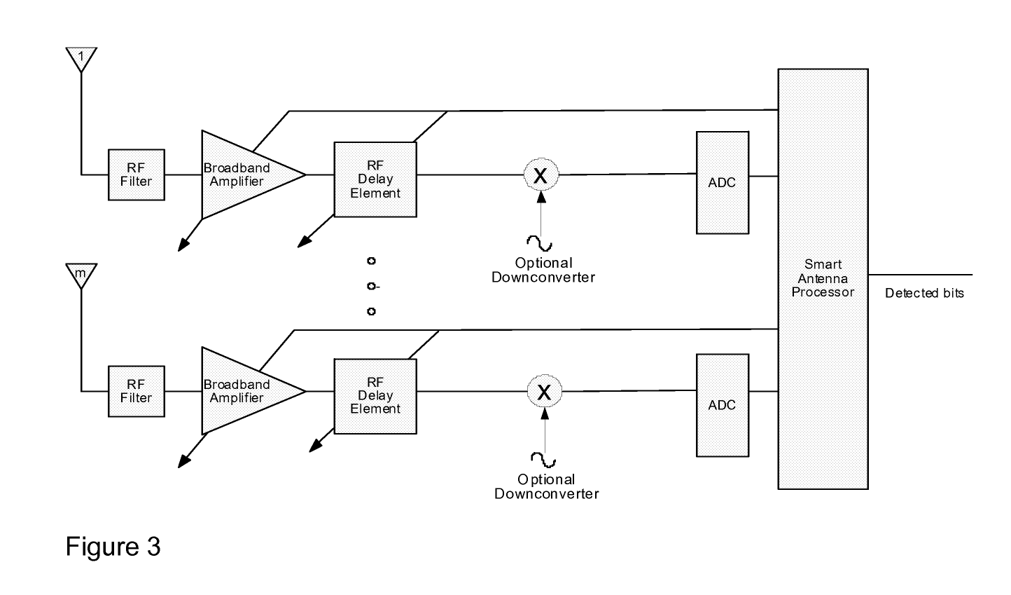

FIG. 3 shows an exemplary embodiment where each of m antennas is connected to the smart antenna processor through a RF filter, a broadband amplifier, a RF delay element, an optional downconverter, and an analog to digital converter (ADC). The m converted digital signals from the m antennas are then combined and processed by the smart antenna processor. The smart antenna processor is connected to the broadband amplifiers and RF delay elements such that it can adjust the gain and delay settings.

In a smart antenna transmit device, an analog baseband signal is optionally upconverted, applied to a splitter, and each individual split signal then optionally upconverted, amplified by a variable gain amplifier and delayed by a programmable delay element before being transmitted on the antenna. The splitter may be applied to the analog baseband signal, or alternatively to the upconverted IF signal, or to the upconverted RF signal. The microprocessor is connected to the programmable RF delay element and the variable gain amplifier for each of the antennas such that the microprocessor can adjust the delay setting of the programmable RF delay elements and the gain setting on the variable gain amplifiers. In one embodiment, the device with which the present device is communicating will communicate the received signal quality obtained at various gain and/or delay settings to the present device, and the microprocessor would select gain and delay settings that produce a high quality signal. In an alternate embodiment, the microprocessor will use the gains and/or delay settings for the smart antenna transmit device that it used for the smart antenna receive device, optionally calibrating for any electronics differences between the transmit chain and the receive chain.

One aspect of the invention is a smart antenna device. In such a smart antenna transmit device, a splitter is connected to each of the multiple antennas through a programmable RF delay element and a variable gain amplifier. The multiple antennas then transmit the split signals. The microprocessor is connected to the programmable RF delay element and the variable gain amplifier for each of the antennas such that the microprocessor can adjust the delay setting of the programmable RF delay elements and the gain setting on the variable gain amplifiers.

The smart antenna device of the present invention has multiple antennas. In some cases, the smart antenna device has 2 to 20 antennas. In some cases, it has 2 to 12 antennas. In some cases, it has 2, 3, or 4 antennas.

A splitter used in this invention is a device that divides a frequency signal into two or more signals, each carrying a selected frequency range.

In some embodiments, the splitter is connected to each antenna additionally through a RF filter. A RF filter used in this invention is an electrical circuit configuration (network) designed to have specific characteristics with respect to the transmission or attenuation of various frequencies that may be applied to it.

In some embodiments, the splitter is connected to each antenna additionally through an optional upconverter, which can bring the signal into the proper frequency band. An upconverter used in this invention may operate to convert a signal from baseband to RF, or from baseband to IF.

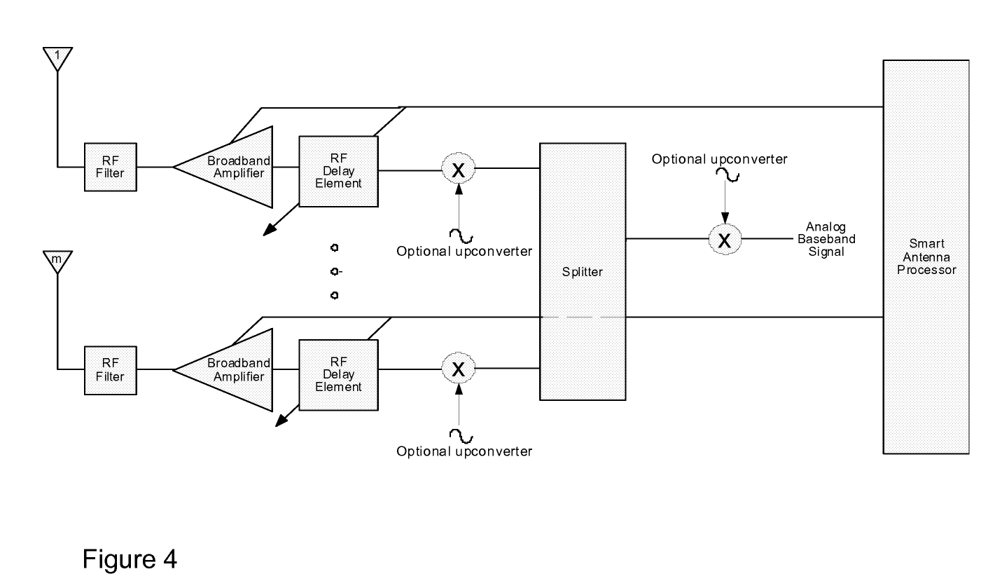

FIG. 4 shows an exemplary embodiment where an analog baseband signal is transmitted to a splitter through an optional upconverter. The splitter is then connected to each of m antennas through an optional upconverter, a RF delay element, a broadband amplifier and a RF filter. The smart antenna processor is connected to the programmable RF delay element and the variable gain amplifier for each of the antennas such that the microprocessor can adjust the delay setting of the programmable RF delay elements and the gain setting on the variable gain amplifiers.

One aspect of the invention is a method for processing and transferring a received radio signal comprising: (a) receiving m first analog signals at m antennas; (b) applying a first set of m gains and a first set of m delays to the m first analog signals; (c) combining the m first analog signals from the multiple antennas into a combined first analog signal; (d) converting the combined first analog signal into a first digital signal; (e) receiving the first digital signal at a microprocessor; (f) receiving m second analog signals at the m antennas; (g) applying a second set of m gains and a second set of m delays to the m second analog signals; (h) combining the m second analog signals from the multiple antennas into a combined second analog signal; (i) converting the combined second analog signal into a second digital signal; (j) receiving the second digital signal at the microprocessor, wherein the microprocessor evaluates the quality of the first digital signal and the second digital signal; and select the gain and delay settings so as to transfer the digital signal with high quality.

The method of the invention uses a smart antenna device with multiple antennas. In some cases, the smart antenna device has 2 to 20 antennas. In some cases, it has 2 to 12 antennas. In some cases, it has 2, 3, or 4 antennas.

In some embodiments, each antenna connected to a RF combiner to an analog to digital converter (ADC) additionally through a RF filter. A RF filter used in this invention is an electrical circuit configuration (network) designed to have specific characteristics with respect to the transmission or attenuation of various frequencies that may be applied to it.

In some embodiments, each antenna connected to a RF combiner to an analog to digital converter (ADC) additionally through a down converter, which can bring the signal into the proper frequency band. A down converter may operate to convert a signal from RF to IF frequency, from RF to baseband, or from IF to baseband.

A variable gain amplifier used in this invention is an electronic amplifier that varies gain depending on a control voltage, which can be adjusted by the microprocessor. In some embodiments, the variable gain amplifier is applied to the RF signal from the antenna. In other embodiments, the variable gain amplifier is applied to the IF signal or the analog baseband signal.

In some embodiments, this method further comprises applying steps (f) through (j) to 1, 2, 3, 4, 5, or 6 additional signals and further evaluating the quality of the additional signals. In some embodiments, this method further comprises applying steps (f) through (j) to 7, 8, 9, 10, 11, or 12 additional signals and further evaluating the quality of the additional signals. In some embodiments, this method further comprises applying steps (f) through (j) to 1-30 additional signals and further evaluating the quality of the additional signals.

The signal quality estimators used can be any suitable method of estimating the quality of a signal. The signal quality estimators include but are not limited to bit error rate (BER), signal-to-noise ratio (SNR), signal-to-interference ratio (SIR), signal-to-noise-and-interference ratio (SINR), error vector measurement, background noise and/or interference power, or received signal strength indicator (RSSI).

In some embodiments, a set of stored weight vectors comprising a set of gain settings and delay settings is used by the microprocessor to pick the best setting of gain and delay to the analog signals. Such a scheme can be referred to as a switched beamforming smart antenna. A switched beamforming smart antenna can have several available fixed beam patterns. The microprocessor makes decision as to which beam to access at any given point in time, based upon the requirements of the system. For example, if there are X number of predefined weight vectors, the microprocessor would collect X number of signals treated by X number of different predefined weight vectors, and then compare them and choose the best quality signal.

In other embodiments, the quality of a digital signal is used by the microprocessor to set a gain, delay or both to subsequent analog signals. Such a scheme can be referred to as an adaptive array smart antenna. An adaptive array smart antenna does not rely only on predefined fixed beam patterns. It allows the antenna to steer the beam to any direction of interest while simultaneously identifying, tracking, and minimizing interfering signals. For example, the microprocessor would construct an estimate of the signal quality from the X received signals which have a particular set of weights being applied. Examples of signal quality estimators are the RSSI (received signal strength indicator), signal to noise ratio, or other quality estimator. The microprocessor would compute the signal quality for one set of weights, make a change in the weights, then recomputed the new signal quality. If the new signal quality is better than the previous, the microprocessor would update to use the new set of weights; if not, it would revert back to the old weights. This process can be iterated.

One aspect of the invention is a method for processing and transferring a received radio signal comprising: (a) the m antennas receive m first analog signals; (b) applying a first set of m gains and a first set of m delays to the m first analog signals; (c) combining the m first analog signals from the multiple antennas into a combined first analog signal; (d) sampling the first analog with a sample and hold circuit, for example wherein the sampled analog value steady for a short time while the slicer can further make a decision based on the held analog value into detected bits; (e) receiving the first set of detected bits at a microprocessor; (f) receiving m second analog signals at the m antennas; (g) applying a second set of m gains and a second set of m delays to the m second analog signals; (h) combining the m second analog signals from the multiple antennas into a combined second analog signal; (i) sampling the second analog with the sample and hold circuit, for example by holding the sampled analog value steady for a short time while the slicer can further make a decision based on the held analog value into second set of detected bits; (j) receiving the second set of sliced bits at the microprocessor, wherein the microprocessor evaluates the quality of the first digital signal and the second digital signal; and select the gain and delay settings so as to transfer the digital signal with high quality. Such a scheme can achieve very low power consumption, but is challenging for the smart antenna processor, which must choose the delays and gains on the basis of the sliced bits. For relatively clean propagation environments, the method can utilize knowledge of the array geometry and using a direction-of-arrival approach to reduce the number of estimation parameters.

The method of the invention uses a smart antenna device with multiple antennas. In some cases, the smart antenna device has 2 to 20 antennas. In some cases, it has 2 to 12 antennas. In some cases, it has 2, 3, or 4 antennas.

In some embodiments, each antenna connected to a RF combiner to an analog to digital converter (ADC) additionally through a RF filter. A RF filter used in this invention is an electrical circuit configuration (network) designed to have specific characteristics with respect to the transmission or attenuation of various frequencies that may be applied to it.

In some embodiments, each antenna connected to a RF combiner to an analog to digital converter (ADC) additionally through a down converter, which can bring the signal into the proper frequency band. A down converter may operate to convert a signal from RF to IF frequency, from RF to baseband, or from IF to baseband.

In some embodiments, this method further comprises applying steps (f) through (j) to 1, 2, 3, 4, 5, or 6 additional signals further evaluating the quality of the additional signals. In some embodiments, this method further comprises applying steps (f) through (j) to 7, 8, 9, 10, 11, or 12 additional signals and further evaluating the quality of the additional signals. In some embodiments, this method further comprises applying steps (f) through (j) to 1-30 additional signals and evaluating the quality of the additional signals.

In some embodiments, the quality estimators include but are not limited to bit error rate (BER), signal-to-noise ratio (SNR), signal-to-interference ratio (SIR), signal-to-noise-and-interference ratio (SINR), error vector measurement, background noise and/or interference power, or received signal strength indicator (RSSI).

In some embodiments, a set of stored weight vectors comprising a set of gain settings and delay settings is used by the microprocessor to pick the best setting of gain and delay to the analog signals. Such a scheme can be referred to as a switched beamforming smart antenna. A switched beamforming smart antenna has several available fixed beam patterns. The microprocessor makes decision as to which beam to access at any given point in time, based upon the requirements of the system. For example, if there are X number of predefined weight vectors, the microprocessor would collect X number of signals treated by X number of different predefined weight vectors, and then compare them and pick the best one.

In other embodiments, the quality of a digital signal is used by the microprocessor to set a gain, delay or both to subsequent analog signals. Such a scheme can be referred to as an adaptive array smart antenna.

An adaptive array smart antenna does not have predefined fixed beam patterns. Instead, it allows the antenna to steer the beam to any direction of interest while simultaneously identifying, tracking, and minimizing interfering signals. For example, the microprocessor would construct an estimate of the signal quality from the X received signals which have a particular set of weights being applied. Examples of signal quality estimators are the RSSI (received signal strength indicator), signal to noise ratio. The microprocessor would compute the signal quality for one set of weights, make a change in the weights, then recomputed the new signal quality. If the new signal quality is better than the previous, the microprocessor would update to use the new set of weights; if not, it would revert back to the old weights. This process is then iterated.

One aspect of the invention is a method for processing and transferring a received radio signal comprising: (a) receiving m first analog signals at m antennas; (b) applying a first set of m gains and a first set of m delays to the m first analog signals; (c) converting the signals from step (b) into m first digital signals; (d) receiving the m first digital signals at a microprocessor; (e) receiving m second analog signals at the m antennas; (f) applying a second set of m gains and a second set of m delays to the m second analog signals; (g) converting signals from step (f) into m second digital signals; and (h) receiving the m second digital signals at the microprocessor, wherein the microprocessor combines the m first digital signals into a combined first digital signal, combines the m second digital signals into a combined second digital signal, evaluates the quality of the first combined digital signal and the second combined digital signal; and select the gain and delay settings so as to transfer the combined digital signal with high quality. Such a scheme provides soft samples along each separate antenna path, allowing the smart antenna processor full access to signal statistics.

The method of the invention uses a smart antenna device with multiple antennas. In some cases, the smart antenna device has 2 to 20 antennas. In some cases, it has 2 to 12 antennas. In some cases, it has 2, 3, or 4 antennas.

In some embodiments, each antenna connected to an analog to digital converter (ADC) additionally through a RF filter. A RF filter used in this invention is an electrical circuit configuration (network) designed to have specific characteristics with respect to the transmission or attenuation of various frequencies that may be applied to it.

In some embodiments, each antenna connected to an analog to digital converter (ADC) additionally through a down converter, which can bring the signal into the proper frequency band. A down converter may operate to convert a signal from RF to IF frequency, from RF to baseband, or from IF to baseband.

In some embodiments, this method further comprises applying steps (e) through (h) to 1, 2, 3, 4, 5, or 6 additional signals and further evaluating the quality of the additional signals. In some embodiments, this method further comprises applying steps (e) through (h) to 7, 8, 9, 10, 11, or 12 additional signals and further evaluating the quality of the additional signals. In some embodiments, this method further comprises applying steps (e) through (h) to 1-30 additional signals and evaluating the quality of the additional signals.

In some embodiments, the quality estimators include but are not limited to bit error rate (BER), signal-to-noise ratio (SNR), signal-to-interference ratio (SIR), signal-to-noise-and-interference ratio (SINR), error vector measurement, background noise and/or interference power, or received signal strength indicator (RSSI).

In some embodiments, a set of stored weight vectors comprising a set of gain settings and delay settings is used by the microprocessor to pick the best setting of gain and delay to the analog signals. Such a scheme can be referred to as a switched beamforming smart antenna. A switched beamforming smart antenna has several available fixed beam patterns. The microprocessor makes decision as to which beam to access at any given point in time, based upon the requirements of the system. For example, if there is X number of predefined weight vectors, the microprocessor would collect X number of signals treated by X number of different predefined weight vectors, and then compare them and pick the best one.

In other embodiments, the quality of a digital signal is used by the microprocessor to set a gain, delay or both to subsequent analog signals. Such a scheme can be referred to as an adaptive array smart antenna. An adaptive array smart antenna does not have predefined fixed beam patterns. Instead, it allows the antenna to steer the beam to any direction of interest while simultaneously identifying, tracking, and minimizing interfering signals. For example, the microprocessor would construct an estimate of the signal quality from the X received signals which have a particular set of weights being applied. Examples of signal quality estimators are the RSSI (received signal strength indicator), signal to noise ratio, and etc. The microprocessor would compute the signal quality for one set of weights, make a change in the weights, then recomputed the new signal quality. If the new signal quality is better than the previous, the microprocessor would update to use the new set of weights; if not, it would revert back to the old weights. This process is then iterated.

One aspect of the invention is a method of transmitting a signal from a smart antenna comprising: (a) sending an analog baseband signal to a splitter which splits the signal into m split signals: (b) applying a set of m gains and m delays to the m split signals; (c) transmitting the m split signals through m antennas (d) repeating steps (a) through (c) with another set of m gains and m delays.

The method of the invention uses a smart antenna device with multiple antennas. In some cases, the smart antenna device has 2 to 20 antennas. In some cases, it has 2 to 12 antennas. In some cases, it has 2, 3, or 4 antennas.

In some embodiments, the splitter is connected to each antenna additionally through a RF filter. A RF filter used in this invention is an electrical circuit configuration (network) designed to have specific characteristics with respect to the transmission or attenuation of various frequencies that may be applied to it.

In some embodiments, the analog baseband signal is upconverted before it reaches the splitter. An upconverter used in this invention may operate to convert a signal from baseband to RF, or from baseband to IF.

In some embodiments, the splitter is connected to each antenna additionally through an optional upconverter, which can bring the signal into the proper frequency band.

In some embodiments, each split signal is filtered through a RF filter before being transmitted by each antenna. A RF filter used in this invention is an electrical circuit configuration (network) designed to have specific characteristics with respect to the transmission or attenuation of various frequencies that may be applied to it.

In some embodiments, the quality estimators include but are not limited to bit error rate (BER), signal-to-noise ratio (SNR), signal-to-interference ratio (SIR), signal-to-noise-and-interference ratio (SINR), error vector measurement, background noise and/or interference power, or received signal strength indicator (RSSI).

In some embodiments, a set of stored weight vectors comprising a set of gain settings and delay settings is used by the microprocessor to pick the best setting of gain and delay to the analog signals. Such a scheme can be referred to as a switched beamforming smart antenna. A switched beamforming smart antenna has several available fixed beam patterns. The microprocessor makes decision as to which beam to access at any given point in time, based upon the requirements of the system. For example, if there is X number of predefined weight vectors, the microprocessor would collect X number of signals treated by X number of different predefined weight vectors, and then compare them and pick the best one.

In other embodiments, the quality of a digital signal is used by the microprocessor to set a gain, delay or both to subsequent analog signals. Such a scheme can be referred to as an adaptive array smart antenna. An adaptive array smart antenna does not have predefined fixed beam patterns. Instead, it allows the antenna to steer the beam to any direction of interest while simultaneously identifying, tracking, and minimizing interfering signals. For example, the microprocessor would construct an estimate of the signal quality from the X received signals which have a particular set of weights being applied. Examples of signal quality estimators are the RSSI (received signal strength indicator), signal to noise ratio, and etc. The microprocessor would compute the signal quality for one set of weights, make a change in the weights, then recomputed the new signal quality. If the new signal quality is better than the previous, the microprocessor would update to use the new set of weights; if not, it would revert back to the old weights. This process is then iterated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A smart antenna receiver comprising m antennas which receive analog signals, wherein each antenna is connected to a RF combiner through (i) a variable gain amplifier, and (ii) a programmable RF delay element, wherein the RF combiner combines the analog signals into a combined analog signal, wherein the RF combiner is connected to an analog to digital converter (ADC) that converts the combined analog signal to a digital signal; wherein the ADC is connected to a microprocessor, wherein the microprocessor receives the digital signals from the ADC, wherein the microprocessor is connected to the programmable RF delay elements and the variable gain amplifiers for each of the m antennas such that the microprocessor can adjust the delay setting of the programmable RF delay elements and the gain setting on the variable gain amplifiers, and wherein the microprocessor evaluates the digital signals obtained at various gain and/or delay settings to select gain and delay settings that produce a high quality signal

2. The smart antenna receiver of claim 1 wherein m is 2-12.

3. The smart antenna receiver of claim 1 wherein m is 2, 3, or 4.

4. The smart antenna receiver of claim 1 wherein each antenna connected to a RF combiner to an analog to digital converter (ADC) additionally through a RF filter.

5. The smart antenna receiver of claim 1 wherein a down converter is included between each antenna and the analog to digital converter (ADC).

6. A smart antenna receiver comprising m antennas which receive analog signals, each antenna connected to an microprocessor through (i) a variable gain amplifier, and (ii) a programmable RF delay element, and (iii) an analog to digital converter (ADC), such that the signals received at the microprocessor are delayed, amplified, and converted from analog to digital signals, wherein the microprocessor combines the digital signals from the m antennas, and wherein the microprocessor is connected to the programmable RF delay elements and the variable gain amplifiers for each of the m antennas such that the microprocessor can adjust the delay setting of the programmable RF delay elements and the gain setting on the variable gain amplifiers, and wherein the microprocessor evaluates the digital signals obtained at various gain and/or delay settings in order to select gain and delay settings that produce a high quality signal.

7. The smart antenna receiver of claim 6 wherein m is 2-12.

8. The smart antenna receiver of claim 6 wherein m is 2, 3, or 4.

9. The smart antenna receiver of claim 6 wherein each antenna connected to a RF combiner to an analog to digital converter (ADC) additionally through a RF filter.

10. The smart antenna receiver of claim 6 wherein a down converter is included between each antenna and the analog to digital converter (ADC).

11. A smart antenna receiver comprising m antennas which receive analog signals, each antenna is connected to a RF combiner through (i) a variable gain amplifier, and (ii) a programmable RF delay element, wherein the RF combiner combines the signals, wherein the RF combiner is connected to a sample and hold circuit that convert the combined analog signals to digital signals; wherein the sample and hold circuit is connected to a microprocessor, wherein the microprocessor receives the digital signal from the sample and hold circuit, wherein the microprocessor is connected to the programmable RF delay elements and the variable gain amplifiers for each of the m antennas such that the microprocessor can adjust the delay setting of the programmable RF delay elements and the gain setting on the programmable amplifiers, and wherein the microprocessor evaluates the digital signals obtained at various gain and/or delay settings in order to select gain and delay settings that produce a high quality signal.

12. The smart antenna receiver of claim 11 wherein m is 2-12.

13. The smart antenna receiver of claim 11 wherein m is 2, 3, or 4.

14. The smart antenna receiver of claim 11 wherein each antenna connected to a RF combiner to a sample and hold circuit additionally through a RF filter.

15. The smart antenna receiver of claim 11 wherein a down converter is included between each antenna and the analog to digital converter (ADC).

16. A smart antenna transmit device comprising a splitter that splits an analog baseband signal into m split signals, and comprising m transmit chains each comprising a programmable delay element, a variable gain amplifier, and an antenna, wherein each of the m delay elements and m amplifiers is connected to a microprocessor, wherein the microprocessor can adjust the gain of the m amplifiers and the delay of the m delay elements.

17. The smart antenna of claim 16 further comprising an upconverter between the analog baseband signal and the splitter.

18. The smart antenna of claim 16 further comprising m upconverters between the splitter the m antennas.

19. The smart antenna of claim 16 further comprising m RF filters between the splitter and the m antennas.

20. The smart antenna of claim 16 wherein m is 2, 3, 4, 5, or 6.

21. A method for processing and transferring a received radio signal comprising:
(a) receiving m first analog signals at m antennas;
(b) applying a first set of m gains and a first set of m delays to the m first analog signals;
(c) combining the m first analog signals from the multiple antennas into a combined first analog signal;
(d) converting the combined first analog signal into a first digital signal;
(e) receiving the first digital signal at a microprocessor;
(f) receiving m second analog signals at the m antennas;
(g) applying a second set of m gains and a second set of m delays to the m second analog signals;
(h) combining the m second analog signals from the multiple antennas into a combined second analog signal;
(i) converting the combined second analog signal into a second digital signal; and
(j) receiving the second digital signal at the microprocessor.
wherein the microprocessor evaluates the quality of the first digital signal and the second digital signal; and select the gain and delay settings so as to transfer the digital signal with high quality.

22. The method of claim 21 wherein the multiple antennas comprise 2, 3, 4, 5, or 6 antennas.

23. The method of claim 21 further comprising applying steps (f) through (j) to 1, 2, 3, 4, 5, or 6 additional signals and in step (j) further evaluating the quality of the additional signals.

24. The method of claim 21 wherein in step (j) the quality comprises BER, SNR, SIR, SINR, error vector measurement, background noise and/or interference power, or RS SI.

25. The method of claim 21 wherein the converting the one analog signal a digital signal is performed by an ADC.

26. The method of claim 21 wherein the converting the one analog signal a digital signal is performed by a sample and hold circuit.

27. The method of claim 21 wherein a set of stored weight vectors comprising a set of gain settings and delay settings is used by the microprocessor to set the gain and delay to the analog signals.

28. The method of claim 21 wherein the quality of a digital signal is used by the microprocessor to set a gain, delay or both to subsequent analog signals.

29. The method of claim 21 wherein the method is applied to a UWB signal.

30. The method of claim 21 wherein the method is applied to a narrowband signal.

31. A method for processing and transferring a received radio signal comprising:
(a) receiving m first analog signals at m antennas;
(b) applying a first set of m gains and a first set of m delays to the m first analog signals;
(c) converting the signals from step (b) into m first digital signals;
(d) receiving the m first digital signals at a microprocessor;
(e) receiving m second analog signals at the m antennas;
(f) applying a second set of m gains and a second set of m delays to the m second analog signals;
(g) converting signals from step (f) into m second digital signals; and
(h) receiving the m second digital signals at the microprocessor;
wherein the microprocessor combines the m first digital signals into a combined first digital signal, combines the m second digital signals into a combined second digital signal, evaluates the quality of the first combined digital signal and the second combined digital signal; and select the gain and delay settings so as to transfer the combined digital signal with high quality.

32. The method of claim 31 wherein the multiple antennas comprise 2, 3, 4, 5, or 6 antennas.

33. The method of claim 31 further comprising applying steps (e) through (h) to 1, 2, 3, 4, 5, or 6 additional signals and in step (h) further evaluating the quality of the additional signals.

34. The method of claim 31 wherein in step (h) the quality comprises BER, SNR, SIR, SINR, error vector measurement, background noise and/or interference power, or RSSI.

35. The method of claim 31 wherein the converting the one analog signal a digital signal is performed by an ADC.

36. The method of claim 31 wherein the converting the one analog signal a digital signal is performed by a sample and hold circuit.

37. The method of claim 31 wherein a set of stored weight vectors comprising a set of gain settings and delay settings is used by the microprocessor to set the gain and delay to the analog signals.

38. The method of claim 31 wherein the quality of a digital signal is used by the microprocessor to set a gain, delay or both to subsequent analog signals.

39. The method of claim 31 wherein the method is applied to a UWB signal.

40. The method of claim 31 wherein the method is applied to a narrowband signal.

41. A method of transmitting a signal from a smart antenna comprising:
(a) sending an analog baseband signal to a splitter which splits the signal into m split signals:
(b) applying a set of m gains and m delays to the m split signals;
(c) transmitting the m split signals through m antennas
(d) repeating steps (a) through (c) with another set of m gains and m delays.

42. The method of claim 41 wherein the analog baseband signal is upconverted before it reaches the splitter.

43. The method of claim 41 wherein each of the m split signals are upconverted before being transmitted by the m antennas.

44. The method of claim 41 wherein each of the m split signals is filtered before being transmitted by the m antennas.

45. The method of claim 41 wherein m is 2, 3, 4, 5, or 6.

46. The method of claim 41 wherein the repeating in step (d) is done 2, 3, 4, 5, 6, 7, or 8 times.

47. The method of claim 41 wherein a set of stored weight vectors comprising a set of gain settings and delay settings is used by the microprocessor to set the gain and delay to the analog signals.

48. The method of claim 41 wherein the quality of a digital signal is used by the microprocessor to set a gain, delay or both to subsequent analog signals.

49. The method of claim 41 wherein the method is applied to a UWB signal.

50. The method of claim 41 wherein the method is applied to a narrowband signal.
